(19) United States
(12) Patent Application Publication
(10) Pub. No.: US 2025/0191560 A1
(43) Pub. Date: Jun. 12, 2025

(54) PLAYBACK DEVICE AND PLAYBACK SYSTEM

(71) Applicant: HARMAN INTERNATIONAL INDUSTRIES, INCORPORATED, Stamford, CT (US)

(72) Inventors: Jue YANG, Shenzhen (CN); Jianwen ZHENG, Shenzhen (CN)

(21) Appl. No.: 18/968,858

(22) Filed: Dec. 4, 2024

(30) Foreign Application Priority Data
Dec. 11, 2023 (CN) 202311696026.X

(51) Int. Cl. G10H 1/00; G10H 1/46; G10L 21/028

(52) U.S. Cl. CPC G10H 1/0025; G10H 1/46; G10L 21/028; G10H 2210/111

(57) ABSTRACT

Disclosed are a playback device and a playback system. The playback device comprises: an audio separation module configured to perform track separation processing on an input audio signal to generate at least two independent track signals, an audio synthesis module configured to process the at least two independent track signals according to a target instruction, and generate a target audio signal, and an audio playback module configured to receive the target audio signal from the audio synthesis module and play back the target audio signal, where the audio separation module, the audio synthesis module, and the audio playback module are all integrated in the playback device.

### CROSS-REFERENCE TO RELATED APPLICATIONS

This application claims priority benefit of Application No. CN 202311696026.X titled, “PLAYBACK DEVICE AND PLAYBACK SYSTEM,” filed on Dec. 11, 2023. The subject matter of this related application is hereby incorporated herein by reference.

### BACKGROUND

### Field of the Various Embodiments

The present disclosure relates to the field of audio processing, and more particularly to a playback device and a playback system.

### Description of the Related Arts

As audio processing are widely applied in the civil and commercial sectors, audio processing is facing higher requirements.

Currently, audio processing usually involves track separation processing, particularly when a user only needs a part of music content in a current audio signal (for example, only the background accompaniment without vocals). Audio separation is usually employed to separate the audio signal into multiple different tracks, and the user's needs are met by playing back the corresponding tracks. However, on the one hand, an ordinary separation model can only separate the audio signal into a vocal track and other background tracks (which, for example, include all other audio content in the audio signal except the vocals), that is, it is limited to separating the vocals, and fails to perform good track separation of the audio signal in more dimensions and contents. This limits the user's use cases and the user experience is poor. On the other hand, current separation models usually run in the cloud rather than on the user's local side (such as the user's current music playback device, etc.). This means that, in order to achieve a track separation process for a target audio signal, the target audio signal needs to be first uploaded to a cloud platform, and then downloaded from the cloud for playback after being processed by the separation model. It is thus not possible to separate tracks of an audio signal being played in real time using the cloud platform, nor is it possible to flexibly adjust performance parameters and proportions of the tracks of the audio signal being played in real time using the cloud platform. This results in the separation steps for track separation being more cumbersome, less real-time, and less flexible and robust.

Therefore, there is a need for a method that makes the process of track separation simpler and more convenient while achieving good track separation, and that enables real-time track separation and synthesis of the target audio signal, that is, flexibly adjusting the performance parameters of the tracks at the audio playback device during the real-time playback of the target audio signal, and that enables more dimensions and levels of track separation in the process of track separation, thereby improving precision and reliability of the track separation and enhancing the user experience.

### SUMMARY

In view of the above problems, the present disclosure provides a playback device and a playback system. The use of the playback device and the playback system provided in the present disclosure enables performance parameters of tracks to be flexibly adjusted at the audio playback device during the real-time playback of a target audio signal while achieving good track separation. The process of track separation is also simpler and more convenient than conventional techniques and enables more dimensions and levels of track separation in the process of track separation, thereby improving precision and reliability of the track separation and enhancing the user experience.

According to an aspect of the disclosure, proposed is a playback device including an audio separation module configured to perform track separation processing on an input audio signal to generate at least two independent track signals, an audio synthesis module configured to process the at least two independent track signals according to a target instruction, and generate a target audio signal, an audio playback module configured to receive the target audio signal from the audio synthesis module and play back the target audio signal, where the audio separation module, the audio synthesis module, and the audio playback module are all integrated in the playback device.

In some embodiments, the at least two independent track signals include at least one of a track signal corresponding to vocals, or a track signal corresponding to a musical instrument.

In some embodiments, the track signal corresponding to the vocals includes at least one of a male lead vocal track signal, a female lead vocal track signal, or a harmonic chorus track signal.

In some embodiments, the track signal corresponding to the musical instrument includes at least one of a guitar track signal, a bass track signal, a drum track signal, or a piano track signal.

In some embodiments, the audio synthesis module includes a to-be-processed track determination submodule configured to receive the target instruction, and determine, in the at least two independent track signals, a to-be-processed track signal based on the target instruction, a track processing submodule configured to adjust performance parameters of the to-be-processed track signal according to the target instruction to generate a processed track signal, and a track synthesis submodule configured to synthesize the processed track signal and other track signals of the at least two independent track signals to generate a target audio signal.

In some embodiments, the track processing submodule is configured to adjust the performance parameters of the to-be-processed track signal by adjusting a volume level of the to-be-processed track signal.

In some embodiments, the target instruction includes a music device to which the playback device is currently connected.

In some embodiments, the music device to which the playback device is currently connected includes at least one of a microphone, or a musical instrument device.

In some embodiments, the to-be-processed track determination submodule is configured to, based on the music device to which the playback device is currently connected, determine a track signal corresponding to the music device, and use the track signal corresponding to the music device as the to-be-processed track signal.

In some embodiments, the track processing submodule is configured to adjust a volume level of the to-be-processed track signal to 0 to generate the processed track signal.

According to another aspect of the present disclosure, proposed is a playback system, including a plurality of playback devices, and at least one of the playback devices being a playback device as described above.

### BRIEF DESCRIPTION OF THE DRAWINGS

In order to more clearly illustrate the technical solutions of the embodiments of the present disclosure, the accompanying drawings to be used in the description of the embodiments will be briefly introduced below, and it will be obvious that the accompanying drawings in the following description are only some of the embodiments of the present disclosure, and that for those of ordinary skill in the art, other accompanying drawings can be obtained based on these drawings without making creative labor. The following accompanying drawings are not intentionally drawn in equal proportions to the actual dimensions.

FIG. 1 illustrates a schematic diagram of a playback device according to an embodiment of the present disclosure;

FIG. 2 illustrates a schematic diagram of an audio synthesis module according to an embodiment of the present disclosure; and

FIG. 3 illustrates a playback process example of a playback device according to an embodiment of the present disclosure.

### DETAILED DESCRIPTION

The technical solutions in embodiments of the present disclosure will be clearly and completely described below in conjunction with the accompanying drawings, and it will be apparent that the embodiments described are only some embodiments of the present disclosure and not all of them. Based on the embodiments of the present disclosure, all other embodiments obtained by those of ordinary skill in the art without making creative labor fall within the scope of protection of the present disclosure.

As illustrated in the present application and the claims, unless clearly indicated in the context as an exception, the words “one,” “a,” “a kind of,” and/or “the” and the like do not refer specifically to the singular, but may also include the plural. In general, the terms “including” and “comprising” indicate only the inclusion of clearly identified steps and elements, which do not constitute an exclusive list, and the method or the device may also contain other steps or elements.

Although the present application makes various references to certain modules in the system according to the embodiments of the present application, any number of different modules may be used and run on the user terminal and/or server. The modules described are merely illustrative, and different aspects of the systems and methods may use different modules.

Flowcharts are used in the present application to illustrate operations performed by a system according to an embodiment of the present application. It should be understood that the preceding or following operations are not necessarily performed in a precise sequence. Instead, various steps may be processed in a reverse order or simultaneously, as required. Meanwhile, it is also possible to add other operations to these processes or to remove a step or steps from these processes.

According to an aspect of the present disclosure, proposed is a playback device 100. It should be understood that the playback device refers to a device for a user to implement real-time audio playback, which is, for example, configured to process and play input audio signals in real time. The playback device may be, for example, a speaker, e.g., a microphone, etc. It may be, for example, a wired playback device, or may be a wireless playback device, such as a Bluetooth sound box or a Bluetooth headset. Embodiments of the present disclosure are not limited by the specific types of the playback devices.

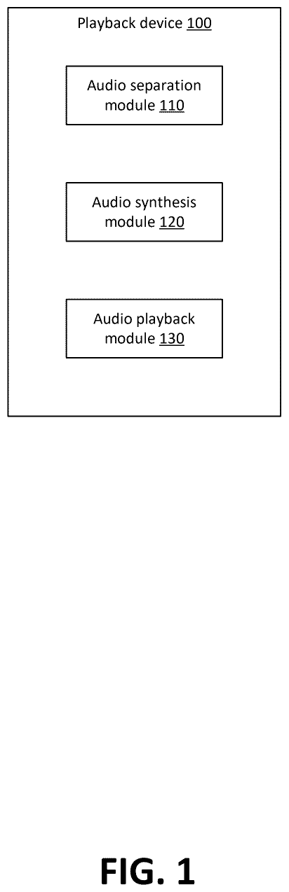

FIG. 1 illustrates a schematic diagram of a playback device 100 according to an embodiment of the present disclosure. Referring to FIG. 1, the playback device 100 includes, without limitation, an audio separation module 110, an audio synthesis module 120, and an audio playback module 130.

The audio separation module 110 refers to a module for implementing track separation of an input audio signal, which is configured to perform track separation processing on the input audio signal to generate at least two independent track signals.

It should be understood that the input audio signal is an audio signal input into the playback device, that is, an audio signal that the playback device is intended to play back, which may be, for example, a song or light music selected by a user, etc.

The track separation processing refers to a process of segmenting signal content of the audio signal, decomposing it into a plurality of different track signals (i.e., audio track signals, or audio channel signals) constituting the audio signal, where each track signal includes different audio content.

It should be understood that the track separation processing can be lossless or almost lossless separation, and the plurality of track signals obtained via track separation can be synthesized to regain the input audio signal, that is, the plurality of track signals can be mixed without loss to obtain an original audio signal.

The track signal refers to a signal representing an audio content in the input audio signal. For example, for a song, the track signal can include, for example, a vocal track signal (representing vocal content in the current song), a musical instrument track signal (representing musical instrument sound content in the current song), and other background track signals (such as background ambient sound in the music, etc.)

It should be understood that a process of performing track separation processing on the input audio signal, for example, can be implemented via a preset algorithm or function, or can also be implemented via a neural network, such as via a convolutional neural network or a conformal neural network. The neural network can, for example, have multiple layers, corresponding to different track signal types (such as vocals, musical instruments, and others), respectively, so that the input audio signal is separated via the respective processing layers and respective track signals are obtained.

It should be understood that only one example method of track separation processing is given above, and embodiments of the present disclosure are not limited thereto.

The independent track signals refer to that the at least two independent track signals obtained by track separation. The independent track signals can be relatively independent of each other, that is, audio contents represented and contained therein are independent of each other, and have no mutual coupling or inclusion relationship.

For example, two independent track signals can be generated according to the input audio signal, or six independent track signals can be generated according to the input audio signal. Embodiments of the present disclosure are not limited by the specific number of the track signals.

The audio synthesis module 120 is configured to process the track signals according to a target instruction and generate a target audio signal.

For example, the audio synthesis module 120 can process one or more of the at least two independent track signals according to the target instruction, and generate the target audio signal based on the processed at least two independent track signals.

It should be understood that the target instruction is intended to represent or contain processing that a user or the system expects to perform on track information in the input audio signal. For example, the target instruction can be command information that has been input by the user, or the target instruction can be system preset instruction information, or the target instruction can be information of the currently connected music device obtained from the playback device 100. Embodiments of the present disclosure are not limited by the specific composition of the target instruction.

The target instruction can be, for example, a directly input instruction, or can be an instruction obtained by further processing and analyzing the acquired instruction. The embodiments of the present disclosure are not limited by how the target instruction is generated.

It should be understood that, for example, only one of the track signals can be processed, such as tuning, muting, or deleting the track signal from all tracks (such as clearing the track signal). Additionally or alternatively, multiple track signals in the to-be-processed track signal can be processed, such as muting or deleting the multiple track signals. It should be understood that embodiments of the present disclosure are not limited by the specific number of the track signals processed.

Processing the track signals according to the target instruction can include, for example, determining, in the at least two independent track signals, a to-be-processed track signal based on the target instruction, adjusting performance parameters of the to-be-processed track signal, and generating a processed track signal.

The target audio signal refers to an audio signal finally output by the playback device 100. Generating the target audio signal means, for example, that the processed track signal and other unprocessed track signals of the at least two independent track signals can be synthesized to generate a target audio signal.

The audio playback module 130 is configured to receive the target audio signal from the audio synthesis module 120 and performs playback of the target audio signal.

It should be understood that, according to actual needs, the audio playback module 130 can, for example, play back (i.e., perform playback of) the target audio signal in different channels, such as playing different track signals via the different channels, or can play back the fused target audio signal via a single channel. Embodiments of the present disclosure are not limited by how the target audio signal is specifically played back.

And, the audio separation module 110, the audio synthesis module 120, and the audio playback module 130 are all integrated in the playback device 100.

It should be understood that the audio separation module 110, the audio synthesis module 120, and the audio playback module 130 are all integrated in the playback device 100, which means that the audio separation module 110, the audio synthesis module 120, and the audio playback module 130 are, for example, each a constituent part of a single playback device.

For example, the audio separation module 110, the audio synthesis module 120, and the audio playback module 130 can be sub-components mounted on a circuit board or chip of the playback device 100, or the playback device 100 can, for example, include a processor component, and the audio separation module 110, the audio synthesis module 120, and the audio playback module 130 can, for example, be functional sub-components within a processor (not shown).

Based on the above, in the present disclosure, with the provisions that the playback device 100 includes the audio separation module 110, an audio synthesis module 120, and the audio playback module 130, that an input audio signal is subjected to track separation processing via the audio separation module 110 and at least two independent track signals are generated, that the at least two independent track signals are processed according to a target instruction via the audio synthesis module 110 and a target audio signal is generated, and that the target audio signal is played back via the audio playback module 130, the present disclosure enables that multiple dimensions and/or levels of track separation for the target audio signal is achieved via a track separation process of more than, or equal to, two independent track signals. Better track separation precision is achieved as compared to the current, ordinary two track signals, so as to meet the user's different needs. In addition, integrating the audio separation module 110, the audio synthesis module 120, and the audio playback module 130 into the real-time playback device 100 enables tracks to be flexibly processed and adjusted according to user needs at the playback device 100 during the real-time playback of audio signals, thereby making the track separation and adjustment process highly real-time and reliable, and improving the robustness of the track separation and adjustment process.

In some embodiments, the at least two independent track signals include at least one of a track signal corresponding to vocals and/or a track signal corresponding to a musical instrument.

The track signal corresponding to the vocals can refer to a signal in the input audio signal representing vocal content, which may be, for example, a single signal, or multiple signals, such as a male lead vocal track signal, a female lead vocal track signal, a harmonic chorus track signal, etc. Embodiments of the present disclosure are not limited by the specific composition of the track signal corresponding to the vocals.

The track signal corresponding to the musical instrument refers to a signal in the input audio signal representing musical instrument content, which can, for example, be a single signal, or multiple signals, such as a guitar track signal, a bass track signal, a drum track signal, a piano track signal, etc.

It should be understood that, according to actual needs, the track signals can also include a background track signal, such as a track signal corresponding to other content in the input audio excluding the vocal track signal and/or the musical instrument track signal, this track signal refers to a signal in the input audio that represents other content besides the vocal content and the musical instrument content, and this track signal can include, for example, an ambient background sound track signal, etc.

It should be understood that, for example, only two track signals can be generated, such as a musical instrument track signal and a track signal of other contents except the musical instrument content (i.e., a background track signal), such as a vocal track signal and a track signal of other contents except the vocal track content (i.e., a background track signal), or, three track signals can also be generated, such as a vocal track signal, a musical instrument track signal, and a track signal of other contents except the vocals and musical instrument (i.e., a background track signal).

Based on the above, in the present disclosure, with the provision that the at least two independent track signals include at least one of a track signal corresponding to vocals and a track signal corresponding to a musical instrument, and with the provision that the track signal is optionally one or more of the vocal track signal and the musical instrument track signal, it is enabled to distinguish and segment the input audio signal in more diverse dimensions, thereby allowing the user to flexibly adjust the track signals according to actual needs (for example, the user may choose to mute the vocal track signal when wanting to sing karaoke, and the user may set the respective musical instrument track signal to mute when wanting to give an instrumental performance), thereby better meeting the user's different needs.

In some embodiments, the track signal corresponding to the vocals includes at least one of a male lead vocal track signal, a female lead vocal track signal, and/or a harmonic chorus track signal.

With the provision that the track signal corresponding to the vocals includes at least one of a male lead vocal track signal, a female lead vocal track signal, and/or a harmonic chorus track signal, it is enabled to further refine and differentiate the track signal for the vocals, so that the input audio signal can be split to a more comprehensive and multi-level degree, enabling the various different track signals to be flexibly adjusted subsequently according to the user's actual needs, and thereby further enhancing the user experience.

In some embodiments, the track signal corresponding to the musical instrument includes at least one of a guitar track signal, a bass track signal, a drum track signal, and/or a piano track signal.

It should be understood that only one example is given above, and track signals corresponding to other musical instruments may also be included according to actual conditions. Embodiments of the present disclosure are not limited thereto.

With the provision that the track signal corresponding to the musical instrument includes at least one of a guitar track signal, a bass track signal, a drum track signal, and/or a piano track signal, it is enabled to split the track signal, particularly instrument types in the input audio signal, to a more comprehensive and multi-level degree, enabling the various different track signals to be flexibly adjusted subsequently according to the user's actual needs, and thereby further enhancing the user experience.

In some embodiments, the audio synthesis module 120 may, for example, be described more specifically.

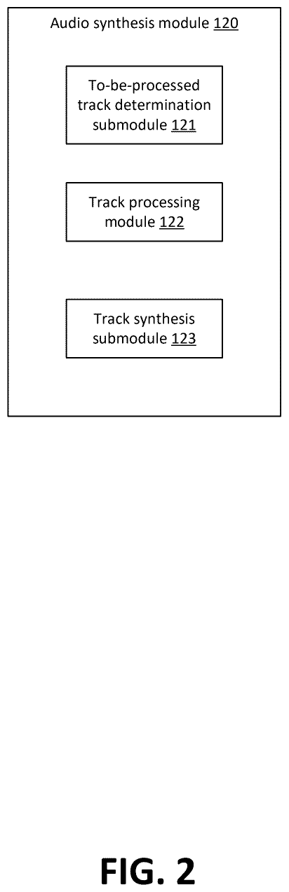

FIG. 2 illustrates a schematic diagram of an audio synthesis module 120 according to an embodiment of the present disclosure. Referring to FIG. 2, the audio synthesis module 120 includes, without limitation, a to-be-processed track determination submodule 121, a track processing submodule 122, and a track synthesis submodule 123.

The to-be-processed track determination submodule 121 is configured to receive the target instruction, and determine, in the track signals (e.g., the at least two independent track signals), a to-be-processed track signal based on the target instruction.

The to-be-processed track signal refers to a track signal in the current track signals that needs to be further processed or adjusted.

For example, the to-be-processed track signal can be determined according to the target instruction based on a preset rule or a preset algorithm, or the respective to-be-processed track signal can be determined by analyzing the target instruction according to a neural network.

For example, if the target instruction is “remove the track signal corresponding to the vocals,” then the track signal corresponding to the vocals can, for example, be used as a to-be-processed target track signal. For example, if the track signal corresponding to the vocals is a single signal (for example, a named vocal track signal), then the named vocal track signal can, for example, be determined as the to-be-processed track signal.

For example, if the target instruction is “play back only the guitar track signal,” then all track signals in the current track signals except the guitar track signal can be used as the to-be-processed track signal.

The track processing submodule 122 is configured to adjust one or more performance parameters of the to-be-processed track signal according to the target instruction to generate a processed track signal.

It should be understood that the one or more performance parameters of the track signal refer to one or more parameters related to performance of the track signal, which may include, for example, volume, pitch, tone, etc. of the track signal. For example, adjusting the one or more performance parameters of the to-be-processed track signal can include adjusting its volume (e.g., a volume level), pitch, and/or tone. However, it should be understood that embodiments of the present disclosure are not limited thereto.

For example, referring to the above, if the target instruction is “remove the track signal corresponding to the vocals,” then the vocal track signal can, for example, be determined as the to-be-processed track signal, and the volume level of the vocal track signal be adjusted to 0 (the vocal track signal muted). If the target instruction is “play back only the guitar track signal,” then the volume of all track signals in the current track signals except the guitar track signal can be adjusted to mute the respective track signal.

The track synthesis submodule 123 is configured to synthesize the processed track signal and other track signals of the at least two independent track signals to generate a target audio signal.

It should be understood that the synthesis processing refers to a process of fusing and rendering multiple track signals to form an overall audio signal. It should be understood that the embodiments of the present disclosure are not limited by the specific manner of the synthesis processing.

For example, referring to the above, the current input audio signal can subjected to audio separation to obtain three track signals, such as a vocal track signal, a guitar track signal, and a background track signal. In such instances, if the target instruction is “remove the track signal corresponding to the vocals,” and the vocal track signal has been processed (i.e., the vocal track signal is muted) to obtain the processed vocal track signal, then, for example, the processed vocal track signal, guitar track signal, and the background track signal can be synthesized to obtain a target audio signal.

Based on the above, in the present disclosure, with the provision that the audio synthesis module 120 includes the to-be-processed track determination submodule 121, the track processing submodule 122, and the track synthesis submodule 123, the audio synthesis module 120 is enabled to determine the track signal to be processed based on the target instruction in a simple and convenient manner, and to process the one or more performance parameters of the track signal and generate a target audio signal, thereby allowing for real-time and reliable track adjustment according to the user's different needs during the real-time playback of audio, and improving the user experience.

In some embodiments, the adjusting of the performance parameters of the to-be-processed track signal includes adjusting the volume level of the to-be-processed track signal.

It should be understood that the volume of the to-be-processed track signal includes enhancing the volume level of the track signal of the to-be-processed signal, and reducing the volume level of the track signal of the to-be-processed signal. Reducing the volume of the track signal of the to-be-processed signal can include adjusting the volume of the to-be-processed track signal to 0.

Based on the above, in the present application, by controlling the volume parameter of the to-be-processed track signal, various track signals can be flexibly adjusted in a simple and convenient manner. For example, when the user does not need certain track signals at this point, the track signals can be removed from the currently playing audio, in real time and conveniently, by muting. In the meantime, when the user needs to enhance certain track signals at a subsequent moment, the track signals can also be enhanced by increasing the volume, thereby allowing for efficient and highly real-time track performance adjustment.

In some embodiments, the target instruction includes a music device to which the playback device 100 is currently connected.

It should be understood that the music device to which the playback device 100 is currently connected refers to other music devices currently connected to the playback device 100, which can, for example, be connected to the playback device 100 via a wired connection, or a wireless connection. Embodiments of the present disclosure are not limited by the manner of connection.

The music device refers to a device related to a music input, which can be, for example, a microphone or a musical instrument, etc., but the embodiments of the present disclosure are not limited thereto.

With the provision that the target instruction includes the music device to which the playback device 100 is currently connected, it is enabled to flexibly or automatically adjust various track signals of an audio signal played in the audio playback device 130 (for example, to correspondingly enhance the volume of the track signals to allow the user to conveniently learn audio content of a respective track, or to reduce the volume of the track signals to allow the user to replace the respective track content via his or her own performances or singing) based on detecting the music device to which the playback device 100 is currently connected, thereby enabling good adaptation to a variety of different music performance scenarios and forms.

In some embodiments, the music device to which the playback device 100 is currently connected includes at least one of a microphone and/or a musical instrument device.

The musical instrument device can include, for example, a guitar, a piano, a bass, a drum, etc., and the embodiments of the present disclosure are not limited by the specific composition of the musical instrument device.

With the provision that the music device includes at least one of a microphone device for vocal singing and/or a musical instrument device for performance, the music device is enabled to comprehensively consider the user's need for personal singing or performances while playing back a target audio signal, and to improve the user's personal experience.

In some embodiments, with the target instruction including the music device to which the playback device 100 is currently connected, the to-be-processed track determination submodule 121 is configured to, based on the music device to which the playback device 100 is currently connected, determine a track signal corresponding to the music device and use the track signal corresponding to the music device as the to-be-processed track signal.

The track signal corresponding to the music device refers to a track signal of a same type as a music device currently connected or joined to the playback device 100. For example, if the device joined is a microphone device (for acquiring vocals), then the track signal corresponding to the vocals can be determined as the corresponding track signal. For example, if the device joined is a certain type of musical instrument (such as a guitar), then the guitar track signal can, for example, be determined as the corresponding track signal.

It should be understood that determining the track signal corresponding to the music device can, for example, be implemented based on a preset rule or a mapping algorithm, or can also be implemented by a preset function or integrated neural network, and the embodiments of the present disclosure are not limited thereto.

By using the track signal corresponding to the music device as the to-be-processed track signal, the playback device 100 is enabled to determine, in a customized manner, the respective to-be-processed track signal according to the actually joined music device, thereby enabling good adaptation to the user's application scenario and application needs.

In some embodiments, with the target instruction including a music device to which the playback device 100 is currently connected, after using the track signal corresponding to the music device as the to-be-processed track signal, the track processing submodule 122 is configured to adjust the volume of the to-be-processed track signal to 0 to generate a processed track signal.

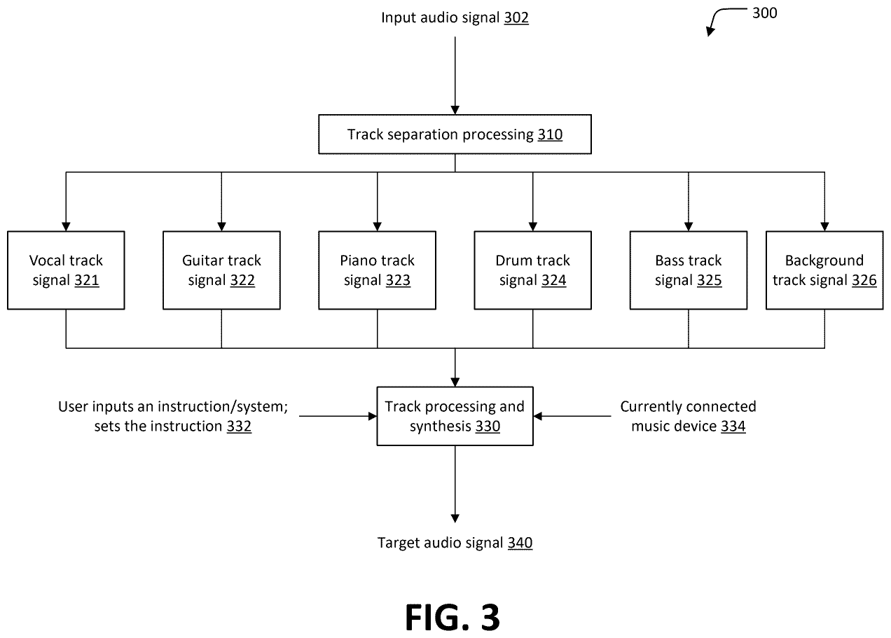

For example, FIG. 3 illustrates a playback process example 300 of a playback device 100 according to an embodiment of the present disclosure. Referring to FIG. 3, an input audio signal 302 in the playback device 100 can first be separated into a vocal track signal 321, a guitar track signal 322, a piano track signal 323, a drum track signal 324, a bass track signal 325, and a background track signal 326 via track separation processing 310. Thereafter, track processing and synthesis 330 would be performed based on the track signals 321-326 and a target instruction 332 to generate a target signal 340.

With the target instruction including a music device to which the playback device is currently connected 334, if the playback device is simultaneously connected to a microphone and a guitar, then based on a preset rule, for example, the audio synthesis module 120 can accordingly determine that the to-be-processed tracks are a vocal track signal corresponding to the microphone (i.e., the vocal signal 321) and the guitar track signal 322 corresponding to the guitar. At this point, the track processing submodule 122 of the playback device 100 can, for example, adjust the volume level of the vocal track signal 321 and/or the guitar track signal 322 to 0, thereby generating a processed vocal track signal and a processed guitar track signal (not shown). Thereafter, in the track synthesis submodule 123, for example, the processed vocal track signal, the processed guitar track signal, the piano track signal 323, the drum track signal 324, the bass track signal 325, and the background track signal 326 can be synthesized to generate the target audio signal 340. At this point, the user may, for example, sing independently through the microphone in the target audio signal 340 (which does not include the vocal signal 321 and the guitar signal 322) played back by the playback device 100, and simultaneously perform respective singing and/or performances through the guitar, thereby helping a singer, a cover singer, or a music learner to play back well audio signals, and allowing such users to use their own vocals and/or instrumental performances to replace relevant contents in original audio, so as to realize their own creation and interpretation.

For example, as in the case described above, with the target instruction 332 including the music device to which the playback device is currently connected 334, the target instruction 332 can also include instructions input by the user and/or instructions set by the system. For example, while the aforementioned playback device 100 is simultaneously connected to a microphone and/or a guitar, and the user, for example, also inputs an instruction “intensify piano sound,” then, for example, on the basis of the aforementioned processing, the volume of the piano track signal 323 can be enhanced to obtain a processed piano track signal, the processed vocal track signal, the processed guitar track signal, the processed piano track signal, the drum track signal 324, the bass track signal 325, and/or the background track signal 326 can be synthesized to generate the target audio signal 340.

Based on the above, in the present disclosure, with further provision that with the target instruction including the music device to which the playback device 100 is currently connected, the track processing submodule 122 is configured to adjust the volume level of the to-be-processed track signal to 0 to generate a processed track signal, enabling the corresponding track in the currently playing audio signal to be flexibly muted according to the music device currently connected to the playback device 100, thereby helping mute the tracks related to the user's music device joined in real time according to the user's needs in the process of playing back music for the user, and thereby enabling good adaptation to the user's playback or performance or partial performance needs and improving the user's experience.

According to another aspect of the present disclosure, proposed is a playback system (not shown). The playback system, for example, includes a plurality of playback devices 100, and at least one of the playback devices 100 is a playback device as described above, which, for example, has the provisions as described above and can implement functions as described above, which will not be described in detail here.

The program portion of the technology may be considered a “product” or “artifact” existing in the form of executable code and/or associated data, which is engaged or implemented through a computer-readable medium. A tangible, permanent storage medium may include the memory or storage used in any computer, processor, or similar device or related module. For example, various semiconductor memories, tape drives, disk drives, or any similar devices capable of providing storage functions for software.

All of the software or portions thereof may from time to time communicate over a network, such as the Internet or other communication networks. Such communication may load software from one computer device or processor to another. For example, loading from one server or host of the device to one hardware platform of a computing environment, or another computing environment implementing the system, or a system of similar functionality related to providing required information. Therefore, another medium capable of transferring software elements may also be used as a physical connection between local devices, such as light wave, radio wave, electromagnetic wave, etc., which are propagated through cables, optical cables, or air. A physical medium used to carry waves, such as cables, wireless connections, optical cables and the like, may also be considered a medium for carrying the software. As used herein, unless restricted to tangible “storage” media, other terms referring to computer or machine “readable media” refer to media that participate in the process of executing any instructions by a processor.

The present application uses specific words to describe embodiments of the present application. For example, “first/second embodiment”, “an embodiment”, and/or “some embodiments” means a feature, structure, or characteristic associated with at least one embodiment of the present application. Accordingly, it should be emphasized and noted that “an embodiment” or “one embodiment” or “an alternative embodiment” referred to two or more times in different places in this specification does not necessarily refer to the same embodiment. In addition, certain features, structures, or characteristics of one or more embodiments of the present application may be combined as appropriate.

In addition, it can be understood by those skilled in the art that aspects of the present application may be illustrated and described by a number of patentable categories or circumstances, including any new and useful process, machine, product, or combination of substances, or any new and useful improvement thereof. Accordingly, aspects of the present application may be performed entirely by hardware, may be performed entirely by software (including firmware, resident software, microcode, or the like), or may be performed by a combination of hardware and software. All of the above hardware or software may be referred to as “data blocks”, “modules”, “engines”, “units”, “components” or “systems”. Additionally, aspects of the present application may be manifested as a computer product disposed in one or more computer-readable media, the product including computer-readable program code.

Unless otherwise defined, all terms used herein, including technical and scientific terms, have the same meaning as commonly understood by those of ordinary skill in the art to which the present disclosure belongs. It should also be understood that terms such as those defined in common dictionaries should be construed as having a meaning consistent with their meaning in the context of the relevant technology and should not be construed with idealized or extremely formalized meanings unless expressly defined as such herein.

The foregoing is a description of the present disclosure and should not be considered a limitation thereof. Although several exemplary embodiments of the present disclosure are described, it will be readily understood by those skilled in the art that many modifications can be made to the exemplary embodiments without departing from the novel teachings and advantages of the present disclosure. Accordingly, all such modifications are intended to be encompassed within the scope of the present disclosure as defined by the claims. It should be understood that the foregoing is a description of the present disclosure and should not be considered to be limited to the particular embodiments as disclosed, and that modifications to the disclosed embodiments, as well as other embodiments, are intended to be included within the scope of the appended claims.

What is claimed is:

1. A playback device, comprising:
an audio separation module configured to perform track separation processing on an input audio signal to generate at least two independent track signals;
an audio synthesis module configured to:
process the at least two independent track signals according to a target instruction, and
generate a target audio signal; and
an audio playback module configured to receive the target audio signal from the audio synthesis module and play back the target audio signal;
wherein the audio separation module, the audio synthesis module and the audio playback module are all integrated in the playback device.

2. The playback device of claim 1, wherein the at least two independent track signals comprise at least one of:
a track signal corresponding to vocals, or
a track signal corresponding to a musical instrument.

3. The playback device of claim 2, wherein the track signal corresponding to the vocals comprises at least one of a male lead vocal track signal, a female lead vocal track signal, or a harmonic chorus track signal.

4. The playback device of claim 2, wherein the track signal corresponding to the musical instrument comprises at least one of a guitar track signal, a bass track signal, a drum track signal, or a piano track signal.

5. The playback device of claim 1, wherein the audio synthesis module comprises:
a to-be-processed track determination submodule configured to:
receive the target instruction, and
determine, in the at least two independent track signals, a to-be-processed track signal based on the target instruction;
a track processing submodule configured to adjust performance parameters of the to-be-processed track signal according to the target instruction to generate a processed track signal; and
a track synthesis submodule configured to synthesize the processed track signal and other track signals of the at least two independent track signals to generate the target audio signal.

6. The playback device of claim 5, wherein the track processing submodule is configured to adjust the performance parameters of the to-be-processed track signal by adjusting a volume level of the to-be-processed track signal.

7. The playback device of claim 5, wherein the target instruction comprises a music device to which the playback device is currently connected.

8. The playback device of claim 7, wherein the music device to which the playback device is currently connected comprises at least one of a microphone, or a musical instrument device.

9. The playback device of claim 7, wherein the to-be-processed track determination submodule is further configured to:
based on the music device to which the playback device is currently connected, determine a track signal corresponding to the music device; and
use the track signal corresponding to the music device as the to-be-processed track signal.

10. The playback device of claim 9, wherein the track processing submodule is configured to adjust a volume level of the to-be-processed track signal to zero to generate the processed track signal.

11. A playback system, comprising:
a plurality of playback devices, wherein at least one of the playback devices comprises:
an audio separation module, configured to perform track separation processing on an input audio signal to generate at least two independent track signals;
an audio synthesis module, configured to:
process the at least two independent track signals according to a target instruction, and
generate a target audio signal; and
an audio playback module, configured to:
receive the target audio signal from the audio synthesis module, and
perform playback of the target audio signal;
wherein the audio separation module, the audio synthesis module and the audio playback module are all integrated in the playback device.

12. A computer-implemented method comprising:
performing, by an audio separation module of a playback device, track separation processing on an input audio signal to generate at least two independent track signals;
processing, by an audio synthesis module of the playback device, the at least two independent track signals according to a target instruction to generate a target audio signal;
receiving, by an audio playback module of the playback device, the target audio signal from the audio synthesis module; and
performing, by the audio playback module, playback of the target audio signal;
wherein the audio separation module, the audio synthesis module and the audio playback module are all integrated in the playback device.

13. The computer-implemented method of claim 12, wherein the at least two independent track signals comprise at least one of:
a track signal corresponding to vocals, or
a track signal corresponding to a musical instrument.

14. The computer-implemented method of claim 13, wherein:
the track signal corresponding to the vocals comprises at least one of a male lead vocal track signal, a female lead vocal track signal, or a harmonic chorus track signal; and
the track signal corresponding to the musical instrument comprises at least one of a guitar track signal, a bass track signal, a drum track signal, or a piano track signal.

15. The computer-implemented method of claim 12, wherein processing the at least two independent track signals comprises:
receiving, by a to-be-processed track determination submodule of the audio synthesis module, the target instruction;
determining, in the at least two independent track signals by the to-be-processes track determination submodule, a to-be-processed track signal based on the target instruction;
adjusting, by a track processing submodule of the audio synthesis module, performance parameters of the to-be-processed track signal according to the target instruction to generate a processed track signal; and
synthesizing, by a track synthesis submodule of the audio synthesis module, the processed track signal and other track signals of the at least two independent track signals to generate the target audio signal.

16. The computer-implemented method of claim 15, wherein adjusting the performance parameters of the to-be-processed track signal comprises adjusting volume of the to-be-processed track signal.

17. The computer-implemented method of claim 15, wherein the target instruction comprises a music device to which the playback device is currently connected.

18. The computer-implemented method of claim 17, wherein the music device to which the playback device is currently connected comprises at least one of a microphone, or a musical instrument device.

19. The computer-implemented method of claim 17, further comprising:
determining, based on the music device to which the playback device is currently connected, a track signal corresponding to the music device; and
using the track signal corresponding to the music device as the to-be-processed track signal.

20. The computer-implemented method of claim 19, further comprising, adjusting, by the track processing submodule a volume level of the to-be-processed track signal to zero to generate the processed track signal.
